(19) United States
(12) Patent Application Publication
(10) Pub. No.: US 2021/0197884 A1
(43) Pub. Date: Jul. 1, 2021

(54) STEERING COLUMN SLEEVE COMPRISING A SYSTEM FOR ADJUSTING A RELATIVE POSITION BETWEEN TWO TUBES

(71) Applicant: ROBERT BOSCH AUTOMOTIVE STEERING VENDOME S.A.S., Vendome (FR)

(72) Inventors: Laurent FÈVRE, Saint Sulpice de Pommery (FR); David CAPELA, Busloup (FR)

(21) Appl. No.: 17/137,652

(22) Filed: Dec. 30, 2020

(30) Foreign Application Priority Data
Dec. 31, 2019 (FR) 191575

(51) Int. Cl. B62D 1/184; B62D 1/19

(52) U.S. Cl. CPC B62D 1/184; B62D 1/19

(57) ABSTRACT

The invention relates to a steering column sleeve (103) comprising two elements consisting of an outer tube (101) and an inner tube (102) which are movable in translation with respect to one another along a reference axis (X), and at least one system (10) for adjusting a resisting force opposing a relative translational movement between the two elements (101, 102), the pressure mechanism comprising: at least one friction pad (20), supported by a first (101) of the two elements (101, 102); a clamping surface (30) secured to a second (102) of the two elements (101, 102), the friction pad (20) being configured to be in contact with and bearing against the clamping surface (30), the second (102) of the two elements (101, 102) having a surface inscribed in a cylindrical casing (E), the steering column sleeve being characterized in that the second (102) of the two elements (101, 102) comprises a guide cavity (40) extending axially with respect to the reference axis (X), the cavity (40) forming a hollow space (41) with respect to the cylindrical casing (E), the friction pad (20) being configured to penetrate at least partially into the guide cavity (40) to guide the translation of the first (101) of the two elements (101, 102) relative to the second (102).

### TECHNICAL FIELD OF THE INVENTION

The invention relates in general to the technical field of systems for adjusting a resisting force opposing a relative translational movement between two elements.

The invention relates more specifically to systems for adjusting a resisting force opposing a relative translational movement between two elements, these two elements being formed in particular by an outer tube and an inner tube of a sleeve of a steering column in order to allow adjustment of the position of a steering wheel, for example in terms of depth, of a vehicle, such as a motor vehicle.

### STATE OF THE PRIOR ART

The steering wheels of motor vehicles are very frequently adjustable in terms of depth and of height by virtue of an adjustment system controlled by a user of the vehicle. Such an adjustment system generally comprises an adjustment mechanism located on a sleeve of a steering column of the motor vehicle and may be manual or electric. In the case of an electrical system, an assembly consisting of a worm gear reducer associated with a screw-nut system converts the rotational movement of an electric motor into translational movement, said electric motor then being sized to achieve the desired adjustment speed in view of the frictional forces which are present in the steering column and more generally in the kinematic chain.

A depth adjustment is generally achieved by means of a telescoping system with two tubes: an outer tube and an inner tube which is configured to translate inside the outer tube, said outer tube comprising a pressure mechanism such as a screw which applies a force to an inner tube. This force is necessary to mask the operating play and to guarantee a minimum stiffness of the connection. The electric motor is then sized to achieve the desired adjustment speed taking these forces into account.

Such pressure mechanisms generally comprise a screw, screwed into a body and secured to the outer tube, provided with an interface allowing it to apply a torque and/or an angle and a friction pad rubbing on the inner tube. Once the various components of the mechanism are in place in the body, a tightening procedure combining torque and angle makes it possible to obtain a compression force with a desired predetermined value which determines the pressure force applied to the inner tube by the friction pad. Such a procedure for adjusting this predetermined value is carried out once at the factory during the manufacture of the steering column. Then, during the phases for adjustment of the steering wheel position by a user, the force necessary to carry out this depth adjustment, whether manual or electric, must overcome this predetermined relative tightening force of the two tubes, corresponding to the tightening of the friction pad against the inner tube, in order to be able to translate one of the tubes relative to the other.

Regardless of the system used to adjust the force resisting the relative translational movement, it appears that the friction pads are always supplemented, on the one hand, by a system ensuring the angular guidance of the inner tube relative to the outer tube during adjustment, and on the other hand, by a system allowing force take-up when torque is applied to the inner tube.

Both of these systems require additional components and manufacturing operations that generate additional costs. This results in a generally bulky, complex and expensive mechanism.

### DISCLOSURE OF THE INVENTION

The invention aims to remedy all or part of the drawbacks of the state of the art by proposing in particular an adjustment system that is easy to use, small in size, and less costly.

To do this, proposed according to a first aspect of the invention is a steering column sleeve comprising two elements consisting of an outer tube and an inner tube which are movable in translation with respect to one another along a reference axis, and at least one system for adjusting a resisting force opposing a relative translational movement between the two elements, the pressure mechanism comprising:
at least one friction pad, supported by a first of the two elements;
a clamping surface secured to a second of the two elements, the friction pad being configured to be in contact with and bearing against the clamping surface,
   the second of the two elements having a surface inscribed in a cylindrical casing, the sleeve of the steering column being characterized in that the second of the two elements comprises a guide cavity extending axially with respect to the reference axis, the cavity forming a hollow space with respect to the cylindrical casing, the friction pad being configured to penetrate at least partly into the guide cavity so as to guide the first of the two elements in translation compared to the second.

Owing to such a combination of features, the same friction pad configured to adjust the resisting force so as to oppose the relative translational movement between the two elements is also configured to cooperate in a guide cavity and thus to ensure the angular guidance of the inner tube relative to the outer tube during their relative translation in the case of an adjustment. Such a guide cavity therefore makes it possible to guarantee freedom of translation during the adjustment and to constrain the angular position of the tubes with respect to each other during this adjustment.

According to one embodiment, the guide cavity is delimited by a continuous wall of the second of the two elements. Such continuity is understood in the length, and in the circumference. Such a cavity can be obtained simply by local deformation of the tubular wall of the tube, for example by stamping or die-forging. Of course, other manufacturing methods can be used to produce such a guide cavity, for example by extrusion or even during the production of the tube, by drawing. Such a feature allows improved reinforcement of the second of the two elements in that the wall is structurally continuous, that is to say, without discontinuity in the structure which could be formed by a hole. Preferably, the thickness of the wall is continuous, or constant, so as to further improve the structural strength of the second of the two elements.

According to one embodiment, the guide cavity has a concave shape. In other words, in such a configuration, the wall, which is preferably continuous, of the second of the two elements that delimits the guide cavity forms a hollow which is oriented toward the inside of the second of the two elements. Such a feature offers a better force take-up when torque is applied to the inner tube and guarantees better precision in guiding the translational movement. According to one embodiment, the wall of the second of the two elements which delimits the guide cavity extends along a casing having a generator with an axis parallel to the reference axis, except possibly at its axial ends.

According to one embodiment, in each section in line with the guide cavity, a perimeter of the wall delimiting the tube of the second of the two elements around the reference axis is closed and continuous, preferably in one piece.

According to one embodiment, the wall along the perimeter of the wall delimiting the tube of the second of the two elements around the reference axis is configured so as to have a substantially constant thickness and/or a constant development. A concave shape of the guide cavity makes it easy to obtain a constant development with simple manufacturing methods to implement. Such a shape of the second of the two elements can be obtained by methods which are simple to implement and from a tube initially formed according to its cylindrical casing. Complex machining is thus avoided, sometimes requiring oversizing of the tube itself to achieve this.

According to one embodiment, the second of the two elements has a perimeter taken in its cross-section around the reference axis, in line with the adjustment cavity, equal to the perimeter of its cylindrical casing.

According to one embodiment, the guide cavity comprises an orifice opening into the wall of the second of the two elements. Such a through orifice may for example be a groove extending parallel to the reference axis and serving as a guide rail for the friction pad so as to guide it during translation and prevent any relative rotation of the two inner and outer tubes.

According to one embodiment, the guide cavity supports at least part of the clamping surface. In such a configuration, the guide cavity is simultaneously configured to guide the friction pad while having surface contact with the friction pad making it possible to guarantee a resistance opposing the translational movement of the two tubes of the sleeve of the steering column.

According to one embodiment, the guide cavity is configured so that, when a torque is applied between the two elements around the reference axis, the second element exerts a force on the friction pad, the resultant of which force preferably has a component orthogonal to the reference axis, for example radial.

According to one embodiment, the guide cavity has two lateral guide walls, preferably symmetrical with respect to one another, for example with respect to a plane parallel to or containing the reference axis, the lateral guide walls being oriented toward the inside of the second of the two elements, the clamping surface being supported by one and/or the other of the lateral guide walls. The orientation of the lateral guide walls is such that, in this configuration, a pivoting of the second of the two elements about the reference axis causes the friction pad to slide along one or the other of the lateral guide walls, depending on the direction of rotation, resulting in a force from said lateral guide wall on the friction pad, the resultant of which has a component parallel to a clamping axis of the adjustment system tending to move the friction pad away from the second of the two elements.

According to one embodiment, the sleeve comprises an energy storage means, configured to exert, directly or indirectly, an elastic stress on the friction pad tending to keep the friction pad in abutment against the clamping surface. Preferably, this energy storage means works at least partially axially, and is generally oriented along the clamping axis. In this way, the elastic stress generated by an energy storage means makes it possible to absorb part of the resultant forces of the guide wall on the friction pad.

According to one embodiment, the adjustment system comprises an annular body which has an outer surface provided with a radial thread extending coaxially with a clamping axis, for example orthogonal or even radial with respect to the reference axis, and configured to cooperate with a threaded hole of the first of the two elements, the annular body being configured to apply a predetermined pressure on the friction pad. In such a configuration, the first of these two members comprises a radial interface in the manner of a screw which can be screwed into the first of the two elements, in particular into a threaded hole of the outer tube.

According to one embodiment, the adjustment system comprises a spring forming an energy storage means, preferably a lock washer, arranged between the annular body and the friction pad. Such a lock washer has a generally conical shape, an axis of symmetry of which is arranged coaxially with the clamping axis in the assembled position of use.

According to one embodiment, the sleeve comprises a plurality of adjustment systems, preferably two, the friction pads of each of the adjustment systems being configured, for example, to penetrate at least partially into the same guide cavity so as to guide the translation of the first of the two elements. It may also be preferred, depending on the uses, for all or part of the friction pads to enter different guide cavities.

According to one embodiment, the second of the two elements comprises the inner tube, the first of the two elements comprising the outer tube of the sleeve.

### BRIEF DESCRIPTION OF FIGURES

Other features and advantages of the invention will emerge on reading the following disclosure, with reference to the appended figures, which illustrate:

FIG. 1: a perspective view of part of a steering column according to one embodiment;

FIG. 2: another perspective view of part of a steering column according to this embodiment;

FIG. 3: a detail of FIG. 2;

FIG. 4A: a sectional view of a friction pad of an adjustment system in a guide cavity according to a first embodiment;

FIG. 4B: a detail of FIG. 4A;

FIG. 4C: a simplified view of FIG. 4B;

FIG. 5: a sectional view of a friction pad of an adjustment system in a guide cavity according to a second embodiment;

FIG. 6: a sectional view of a friction pad of an adjustment system in a guide cavity according to this second embodiment, in a position under stress;

FIG. 7: a sectional view of a friction pad of an adjustment system in a guide cavity according to a third embodiment;

FIG. 8: a sectional view of a friction pad of an adjustment system in a guide cavity according to a fourth embodiment;

FIG. 9: a sectional view of a friction pad of an adjustment system in a guide cavity according to a fifth embodiment;

FIG. 10: a sectional view of a first friction pad of an adjustment system in a guide cavity according to a sixth embodiment;

FIG. 11: a sectional view of a second friction pad of an adjustment system in a guide cavity according to this sixth embodiment.

For greater clarity, identical or similar elements are identified by identical reference signs in all of the figures.

### DETAILED DESCRIPTION OF AN EMBODIMENT

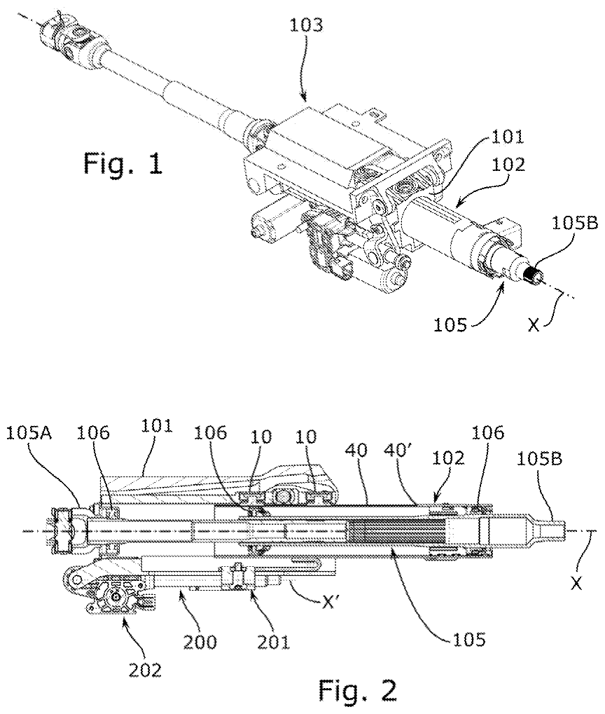

FIGS. 1 and 2 illustrate perspective views of part of a steering column 103 of a motor vehicle such as a car, provided with a sleeve 103. The sleeve 103 of the steering column is of the type comprising a telescoping system with two tubes 101, 102, an outer tube 101 and an inner tube 102 configured to translate inside the outer tube 101 along a reference axis X. The steering column comprises an axis, such as a steering shaft 105, guided in rotation in the sleeve 103, generally by plain or rolling bearings 106. The inner 102 and outer 101 tubes of the sleeve 103 are axially passed through by the steering shaft, which has a distal end 105B protruding from the inner tube 102 and configured to be connected directly or indirectly to a steering wheel (not shown). Another end 105A of the steering shaft, projecting relative to the outer tube 101, in turn has an interface such as a cardan shaft serving as an angle transmission for rotating a pinion meshing with a steering rack (not shown). The depth adjustment of the steering wheel for a user is enabled in particular owing to the translation of the inner tube 102 relative to the outer tube 101 of the sleeve 103.

To drive and guide this relative translation of the tubes 101, 102 with respect to each other, a drive mechanism is provided with a drive screw 200 for the relative axial position of the tubes 101, 102 extending along an axis X′ parallel to the reference axis X and connected to the outer tube 101 which is fixed during axial adjustment. In this way, the drive screw 200 is secured in translation with the outer tube 101 by means of guide bearings, for example two, which are configured to guide the drive screw 200 in rotation about its axis X′. The drive screw 200 meshes with a nut 201 secured to the inner tube 102 so that a rotation of the drive screw 200 about its axis X′ drives a displacement of the nut 201 in translation with respect to the drive screw 200 parallel to the reference axis X, and therefore an axial displacement of the inner tube 102 relative to the outer tube 101.

To hide the operating play and guarantee a minimum stiffness of the connection of the two tubes 101, 102 relative to each other, the sleeve 103 of the steering column is provided with at least one friction pad 20, in particular two in this illustrated embodiment, which are supported by the outer tube 101 and configured to come into contact with and bear against a clamping surface 30 of the inner tube 102. The system is configured so that a predetermined pressure of the friction pad 20 supported by the outer tube 101 is applied against the clamping surface 30 of the inner tube 102. Such a pressure of the pad 20 aims to increase a resisting force so as to oppose the relative translational movement between these two elements formed by the outer 101 and inner 102 tubes.

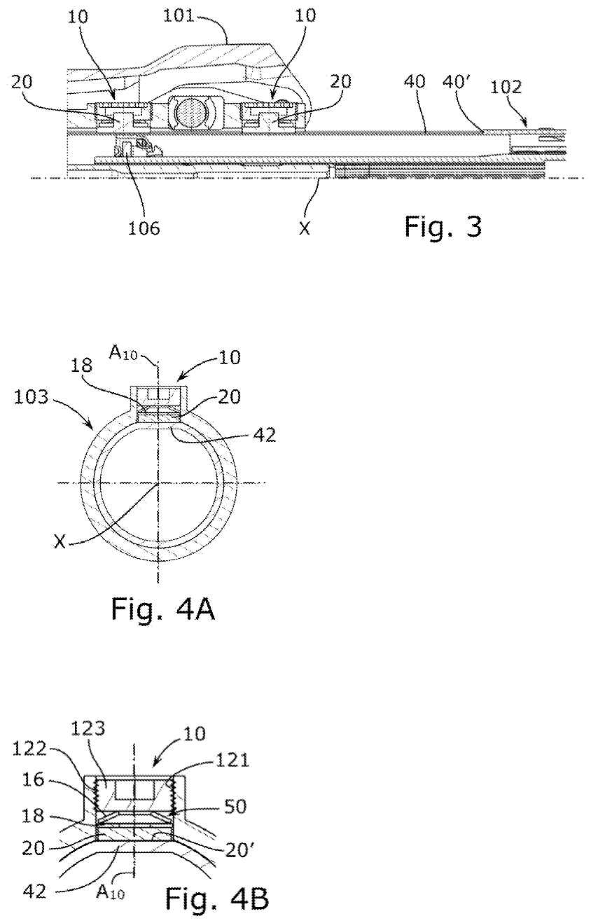

In the embodiment illustrated in FIGS. 1, 2 and 3, the sleeve 103 of the steering column comprises two adjustment systems 10. The invention proposes to integrate, into at least one of the friction pads 20, at least one function of guiding the translation of the outer tube 101 relative to the inner tube 102.

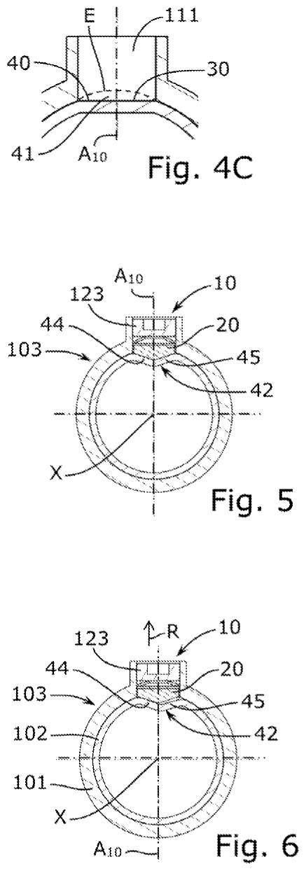

FIGS. 4A, 4B and 4C illustrate a first embodiment. The inner tube 102 has an outer surface inscribed in a cylindrical casing E, and the outer tube 101 has a cylindrical inner surface. The inner surface of the outer tube 101 delimits an inner tubular space within which the inner tube 102 penetrates and cooperates such that this cooperation forms a sliding pivot link between the two tubes 101, 102.

The second 102 of the two elements 101, 102, or the inner tube 102, is provided with a guide cavity 40 forming a hollow space 41 relative to the cylindrical casing E (see FIG. 4C). This guide cavity 40 extends axially with respect to the reference axis X. The guide cavity 40 is borne by the inner tube 102 and is open, substantially radially outward, precisely toward the outer tube 101 when it is located on a portion covered by said outer tube 101. At least one of the two friction pads 20 is configured to penetrate at least partly into the guide cavity 40 so as to guide the translation of the outer tube 101 relative to the inner tube 102, the friction pad 20 forming an obstacle to the relative rotation of the tubes 101, 102 with respect to each other. The sliding pivot link produced by the two inner 102 and outer 101 tubes is thus constrained in a sliding connection owing to the friction pads 20 so that the inner tube 102 translates inside the outer tube 101 along the reference axis X.

The guide cavity 40 is delimited axially by its two opposite ends 40′. In practice, a translation mechanism for the two tubes is controlled by the drive screw 200, which in turn is controlled in rotation directly or indirectly by a geared motor 202. The translation mechanism is further configured so that the translation does not reach its two ends 40′, in particular by the installation, on the sleeve, of stops so as to limit the translation of the two tubes 101, 102 relative to each other in one direction and/or both directions of translation. In the event of a collision of the vehicle, in particular of exceptional translation of the two tubes 101, 102 in the direction of a retraction of the inner tube 102 into the outer tube 101 beyond a nominal adjustment stroke, for example between 20 and 30 mm, the end 40′ or the stop associated with the guide cavity 40 can be configured to participate in shock absorption. Advantageously, the guide cavity 40 allows translational guiding of the tubes 101, 102 during a collision, along a collision course extending beyond the nominal adjustment stroke, for example over 80 or 100 mm so that the guide system does not interfere with the collision absorption system. In practice, the guide cavity 40 extends axially, on either side of the clamping surface 30 against which the one or more friction pad(s) 20 bear, over a distance corresponding to the useful stroke of the inner tube 102 in the outer tube 101.

The guide cavity 40 extends laterally along a width configured so that said guide cavity extends over an angular sector of a circumference of the inner tube 102 which is at least equal to 20 degrees, preferably 30 degrees and less than or equal to 60 degrees, preferably less than or equal to 45 degrees.

In this embodiment, the guide cavity 40 is delimited by a continuous wall 42 of the second 102 of the two elements 101, 102. In particular, in each section in line with the guide cavity 40, the perimeter of the wall delimiting the tube around the reference axis X is closed and continuous, preferably in one piece. Likewise, the wall along this perimeter is preferably configured so as to have a substantially constant thickness. The wall 42 delimiting the guide cavity 40 forms a flat with respect to the cylindrical casing E of the inner tube 102. The wall 42 has a flat outer surface 42′ against which the associated friction pad 20 comes into contact and bears, creating a resisting force opposing a relative translational movement between the two elements 101, 102. The guide cavity 40 supports the clamping surface 30, said clamping surface 30 here constituting part of the outer surface 42′ of the wall 42 delimiting the guide cavity 40. A friction surface 20′ of the friction pad 20 provided to rub against the clamping surface 30 has a complementary planar shape so as to maximize the surface contact with the clamping surface 30.

As illustrated in more detail in FIG. 4B, the adjustment system 10 comprises an annular body 123 having an outer surface 121 provided with a thread 122 which is orthogonal to the reference axis X, in particular here radial, and configured to cooperate with a threaded hole 111 of the outer tube 101. The annular body 123 is configured to apply a predetermined pressure to the friction pad 20 in the manner of a clamping nut.

The adjustment system further comprises an energy storage means 50, configured to exert, directly or indirectly, an elastic stress on the friction pad 20 tending to keep the friction pad 20 in abutment against the clamping surface 30, despite any vibrations in dynamic behavior of the vehicle, or to press the friction pad against the inner tube 101 during an adjustment. The energy storage means 50 comprises a lock washer 16 disposed between the annular body 123 and the friction pad 20, the lock washer 16 having a substantially conical shape, a base of which is oriented on the side of the friction pad 20. The lock washer 16 produces a pressure force as a function of its compression. The lock washer 16 has a stiffness allowing it to generate the force making it possible, depending on the screwing of the annular body 123 in the threaded hole 111 provided for this purpose, to guarantee the minimum stiffness of the connection between the two outer 101 and inner 102 tubes.

This bearing of the lock washer 16 against the friction pad here is indirect, since the adjustment system 10 comprises a flat distribution washer 18, centered on a clamping axis A₁₀ and interposed between the lock washer 16 and the friction pad 20. Such a flat washer 18 has the function of distributing a force of the lock washer 16 on the surface of the friction pad 20, thus making it possible to distribute the pressure forces evenly on the friction pad 20.

The annular body 123 forming a screw nut, the lock washer 16, the flat washer 18, and the friction pad 20 are aligned along the clamping axis A₁₀ orthogonal to the reference axis X, and in particular here radial with respect to said reference axis X.

During manufacture, and once these various components are in place in the threaded hole 111, a tightening procedure combining torque and angle makes it possible to obtain the compression of the lock washer 16 to a desired value which determines the force applied to the inner tube 102 by the associated friction pad 20.

The friction pad 20, in rear contact with the washer 18 and rubbing frontally on the clamping surface 30 of the inner tube 102, is made of thermoplastic material with the possibility of adding a lubricating filler thereto. The friction pad 20 can also be made of a metallic material such as sintered bronze, for example.

The guide cavity 40 is configured so that, when a torque is applied between the inner 102 and outer 101 tubes around the reference axis X, the inner tube 102 exerts a force on the friction pad 20, the resultant of which has a component R parallel to the clamping axis A₁₀. Indeed, a rotation of the inner tube 102 causes pivoting of the guide cavity 40, in particular of the flat outer surface 42′ against which the friction pad 20 is bearing. This pivoting creates a force on the friction pad 20, a resultant R of which is directed in a direction opposite that of its bearing and tends to move the friction pad 20 away from the flat surface 30.

When a torque is applied to the inner tube 102, this tends to move the friction pad 20 up toward the clamping nut 123. This movement is initially prevented by the force exerted by the lock washer 16. This ensures precise guidance of the translation of the inner tube 102 relative to the outer tube 101 during the phases of adjusting the axial position of the steering wheel, where a relatively low torque is likely to be applied to the inner tube 102.

When the torque increases, the force of the lock washer 16 is no longer sufficient to prevent the movement and the latter is compressed “fully” or until it is at the maximum compression stop. This position corresponds to a position of maximum compression of the lock washer 16, which then has zero deflection and a generally planar shape. The force then is taken up by the annular body 123 forming a clamping nut. This thus ensures torque take-up, even with a significant value, for example when a force is applied to the steering wheel while an anti-theft device is engaged, the anti-theft device generally comprising a locking bolt blocking its rotation (not illustrated).

FIGS. 5 and 6 illustrate sectional views of a friction pad 20 of an adjustment system 10 in a guide cavity 40 according to a second embodiment.

This embodiment essentially differs from the first embodiment in that the guide cavity 40 is no longer formed by a single continuous flat wall 42, but by a continuous wall 42 having a concave section, in particular here in the form of a vee or “V.” More precisely, the guide cavity 40 has two lateral guide walls 44, 45 formed together in one piece with the wall of the inner tube 102, both lateral guide walls 44, 45 being directed or oriented toward the inside of the inner tube 102 so as to form the guide cavity 40, which has a concave shape.

The guide cavity 40 supports the clamping surface 30. Indeed, the friction pad 20 comprises a friction surface 20′ having a substantially complementary shape with a vee profile which co-operates in the guide cavity 40. Thus, the convex shape of the friction pad 20 is configured to interface with the concave shape of the guide cavity 40 made in the inner tube 102.

The friction pad 20 may have an axis of symmetry of revolution which is parallel or even coaxial to the clamping axis A₁₀ by taking an inverted conical shape for example to cooperate in the vee shape and to rub against the two lateral guide walls 44, 45. In another preferred configuration, in particular to maximize the friction surfaces of the surface contact between the friction pad 20 and the guide cavity 40, the friction pad 20 may have two slopes, especially with symmetry with respect to a plane parallel to a plane containing the clamping axis A₁₀, for example in the form of an inverted prism with a triangular base. The clamping surface 30 is supported by the two lateral guide walls 44, 45.

FIG. 6 illustrates a position of the friction pad 20 when a torque is applied to it by the inner tube 102. Owing to the slopes provided at its guide interface, in particular by means of the lateral guide walls 44, 45 delimiting the concave guide cavity 40, the latter being in the form of a vee, the friction pad 20 deviates radially under the effect of the force exerted by the lock washer 16, until it comes into contact with an inner wall of the hole 111 housed in the outer tube. The symmetry of the lateral guide walls 44, 45 allows similar torque take-up whether the applied torque is in one direction or the other. The guiding of the inner tube 102 is thus precise and the torque adjustment has little or no impact on its precision. Furthermore, unlike a flat wall 42, this concave shape with inclined lateral walls, of constant inclination in this embodiment, offers a better force take-up when torque is applied to the inner tube 102 and guarantees better precision in guiding the translational movement. Preferably, the inclination of the guide walls is strictly less than 90 degrees with respect to a straight line tangent to the casing E, preferably greater than or equal to 30 degrees and preferably less than or equal to 60 degrees. Preferably, the guide cavity 40 is made so that the section of the tube remains constant, even the thickness and its development. The perimeter of the tube is then equal to the perimeter of a perfectly cylindrical tube of the same diameter not having such a guide cavity 40, namely equal to the perimeter of its casing E (see in particular FIGS. 5, 6, 7, 8, 10 and 11).

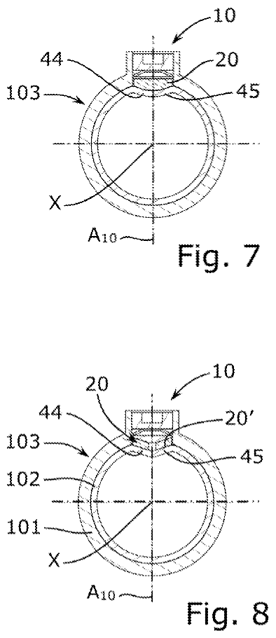

FIG. 7 illustrates a sectional view of a friction pad 20 of an adjustment system 10 in a guide cavity 40 of concave shape according to a third embodiment.

This embodiment essentially differs from the second embodiment in that the guide cavity 40 of concave shape is not formed by a continuous single wall 42 having a section in the form of a vee “V,” but has an arcuate section. The wall is thus continuous with respect to the wall of the body of the tube, of constant thickness at the guide cavity 40. The wall 42 has a variable inclination, of constant variation, allowing a more progressive take-up of forces than a vee shape. Preferably, the circular arc of the section of the guide cavity 40 has a curve radius substantially equal to the radius of the tube which supports it, namely here of the inner tube 102.

It will be noted that the arcuate section of the wall 42 delimiting the guide cavity may have another shape, for example the shape of an oval arc.

FIG. 8 illustrates a sectional view of a friction pad 20 of an adjustment system 10 in a guide cavity 40 according to a fourth embodiment.

This embodiment essentially differs from the second embodiment in that the same adjustment system 10 comprises a friction pad 20 provided with two distinct and separate friction surfaces 20′, each friction surface 20′ here being supported by two friction elements. It will be noted that it is alternately possible to provide a friction pad in a single part, the shape of which is configured to have two friction surfaces 20′, for example in the form of a pad having an inverted “U”-shaped section. Each of these two friction surfaces 20′ is configured to be in contact with and in abutment against the clamping surface 30 supported by the guide cavity 40, in particular in distinct contact with and bearing against each of the clamping surfaces 30 carried by the lateral guide walls 44, 45. The advantage of this embodiment is to hide the play that may exist between the friction pad 20 and the body 101, the two friction elements or half-pads coming to rest on the inner surface of the hole 111.

Owing to the guide cavity 40, the two friction elements of the friction pad 20 move apart under the effect of the torque exerted by the inner tube 102 on one of the two elements of the friction pad 20, the force exerted by the friction pad 20 comprising a component parallel to the clamping axis A₁₀ so that it is taken up by the lock washer 16 and by the annular body 123 forming a nut.

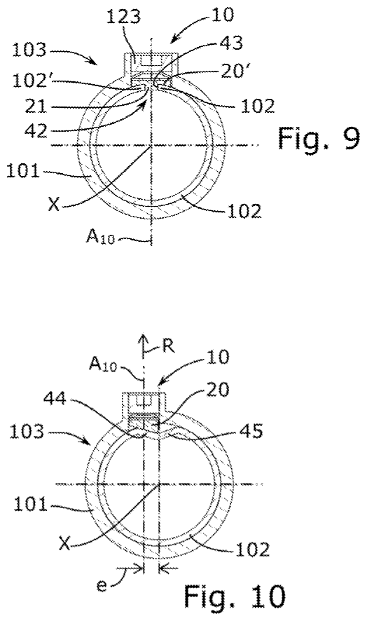

FIG. 9 illustrates a sectional view of a friction pad 20 of an adjustment system 10 in a guide cavity 40 according to a fifth embodiment.

This embodiment differs from the previous embodiments in that the guide cavity 40 comprises an orifice 43 opening into the wall of the second 102 of the two elements 101, 102, such a configuration, however, allowing less good torque take-up by the energy storage means 50.

Here, the guide cavity 40 does not support the clamping surface 30, said clamping surfaces being borne by the side walls 102′ bordering the orifice extending axially parallel to the reference axis X such as a guide groove. The clamping surface 30 is therefore borne by the edges of the cylindrical body of the inner tube 102.

According to this embodiment, the guide cavity 40 is not configured so that, when a torque is applied between the inner 102 and outer 101 tubes around the reference axis X, the inner tube 102 exerts a force on the friction pad 20, the resultant of which has a component R parallel to the clamping axis A₁₀. However, it will be noted that the rim of these edges may include slopes (not shown) configured so that when a torque is applied between the two elements 101, 102 around the reference axis 100, the rim of said inner tube edges 102 exerts such a force on the friction pad 20.

The friction pad 20 is made in a single piece and has a central projection 21 separating two wings bearing lateral friction surfaces 20′, each of these friction surfaces 20′ coming into surface contact and bearing against one and the other of the two outer surfaces of the cylindrical body of the inner tube 102 bordering the orifice 43, on either side of the central projection 21.

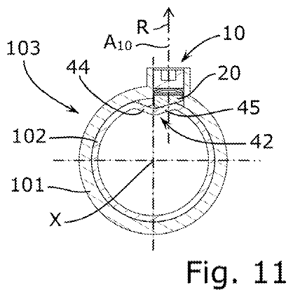

FIGS. 10 and 11 show sectional views of a first friction pad 20A and a second friction pad 20B of an adjustment system 10 in a guide cavity 40 according to a sixth embodiment.

The sleeve 103 of the steering column comprises two adjustment systems 10, the friction pads 20 of each of the adjustment systems 10 being configured to penetrate at least in part into the same guide cavity so as to guide the first 101 of the two elements 101, 102 in translation.

The guide cavity 40 here is similar to that of the second and fourth embodiments and has a vee-shaped section. However, here, the first friction pad 20A of a first adjustment system 10 ensures the guiding and the take-up of torque in a given direction, clockwise (see FIG. 10), while the second friction pad 20B of a second adjustment system 10 ensures the guiding and the take-up of torque in the other direction, counterclockwise (see FIG. 11). This makes it possible to hide the play between the friction pad 20 and the outer tube 101.

Unlike the previous embodiments, in this sixth embodiment, the clamping axes A₁₀ of the adjustment systems 10 are not radial, but are orthogonal to the reference axis X and parallel to a plane containing the radial axis with a predetermined center distance e in a transverse plane, the center distance e being substantially equal here to the radius of the corresponding threaded hole 111.

Of course, the invention is described in the above by way of example. It is understood that a skilled person is in a position to produce various variant embodiments of the invention without, however, departing from the scope of the invention.

For example, the clamping axis A₁₀ can be oriented differently than orthogonally to the reference axis. In this case, the clamping axis is at least carried by an axis which is not parallel to the reference axis, either by a non-coplanar axis, or by a secant axis.

To increase the precision of the guidance, the friction part can be extensible, that is to say, it can extend laterally either radially with respect to the clamping axis, or comprise a plurality of friction elements, for example more than two.

In the case where the sleeve of the steering column comprises a plurality of adjustment systems, it is understood that one of the adjustment systems may comprise a conventional friction pad in contact with and bearing against a cylindrical zone of the inner tube while a second, or more, adjustment system comprises a friction pad configured to ensure the guiding and the take-up of the torque.

Furthermore, it is understood that the adjustment system may have a different structure without altering the function of the friction pad. For example, the adjustment systems can be controlled electrically.

The guide cavity may also comprise a combination of a space delimited by a wall 42 of the second of the two elements, whether the surface(s) are flat or inclined, and a through hole. The wall 42 is discontinuous in this case.

Furthermore, in another embodiment an inverted configuration of the friction pad and of the guide cavity may optionally be envisaged. In this configuration, the second of the two elements comprises the outer tube and the second of the two elements comprises the inner tube of the sleeve, the friction pad then being supported by the inner tube. The guide cavity would then be formed by a hollow space relative to a cylindrical casing in which the inner surface of the outer tube is inscribed, inside which the inner tube is housed. The guide cavity is then borne by the outer tube and is open, substantially radially inward, precisely toward the inner tube when it is located on a portion through which said inner tube passes.

The adjustment systems may have a different structure with regard to their adjustment. In particular, a control mechanism can be integrated so as to control the adjustment system, the adjustment mechanism for example comprising a cam bearing directly or indirectly on a support so as to generate a pressure variation of the friction pad relative to the clamping surface parallel to the clamping axis, fixed relative to the first of the two elements, so as to vary the pressure force of the friction pad against the clamping surface of the second of the two elements, between: a usage position, in which a predetermined operating pressure of the friction pad is applied against the clamping surface of the second of the two elements; and an adjustment position, in which an adjustment pressure lower than the operating pressure is applied by the friction pad against the clamping surface of the second of the two elements.

1. A steering column sleeve comprising two elements consisting of an outer tube and an inner tube which are movable in translation with respect to one another along a reference axis, and at least one system for adjusting a resisting force opposing a relative translational movement between the two elements, the pressure mechanism comprising:
at least one friction pad, supported by a first of the two elements;
a clamping surface secured to a second of the two elements, the friction pad being configured to be in contact with and bearing against the clamping surface,
the second of the two elements having a surface inscribed in a cylindrical casing, wherein the second of the two elements comprises a guide cavity extending axially with respect to the reference axis and being delimited by a continuous wall of the second of the two elements, the guide cavity forming a hollow space with respect to the cylindrical casing and having a concave shape, the friction pad being configured to penetrate at least partly into the guide cavity so as to guide the first of the two elements in translation relative to the second, the guide cavity supporting at least part of the clamping surface.

2. The steering column sleeve of claim 1, wherein, in each section in line with the guide cavity, a perimeter of the wall delimiting the tube of the second of the two elements around the reference axis is closed and continuous, preferably in one piece.

3. The steering column sleeve of claim 2, wherein the wall along the perimeter of the wall delimiting the tube of the second of the two elements around the reference axis is configured so as to have a constant thickness and/or a constant development.

4. The steering column sleeve according to claim 1, wherein the second of the two elements has a perimeter taken in its cross-section around the reference axis, in line with the adjustment cavity, equal to the perimeter of its cylindrical casing.

5. The steering column sleeve according to claim 1, wherein the guide cavity is configured so that, when a torque is applied between the two elements around the reference axis, the second of the two elements exerts a force on the friction pad, the resultant of which force preferably has a component orthogonal to the reference axis.

6. The steering column sleeve according to claim 5, wherein the guide cavity has two lateral guide walls, preferably symmetrical with respect to one another, the lateral guide walls being oriented toward the inside of the second of the two elements, the clamping surface being supported by one and/or the other of the lateral guide walls.

7. The steering column sleeve according to claim 1, wherein it comprises an energy storage means, configured to exert, directly or indirectly, an elastic stress on the friction pad tending to keep the friction pad in abutment against the clamping surface.

8. The steering column sleeve according to claim 1, wherein the adjustment system comprises an annular body which has an outer surface provided with a radial thread extending coaxially with a clamping axis, for example orthogonal or even radial with respect to the reference axis, and configured to cooperate with a threaded hole of the first of the two elements, the annular body being configured to apply a predetermined pressure on the friction pad.

9. The steering column sleeve according to claim 8, wherein the adjustment system comprises a spring forming an energy storage means, preferably a lock washer, arranged between the annular body and the friction pad.

10. The steering column sleeve according to claim 1, wherein it comprises a plurality of adjustment systems, preferably two, the friction pads of each of the adjustment systems being configured to penetrate at least partially into the same guide cavity so as to guide the translation of the first of the two elements.
